(19) United States
(12) Patent Application Publication
(10) Pub. No.: US 2023/0179509 A1
(43) Pub. Date: Jun. 8, 2023

(54) COMMUNICATION DEVICE, COMMUNICATION METHOD, COMMUNICATION SYSTEM, AND PROGRAM

(71) Applicant: NIPPON TELEGRAPH AND TELEPHONE CORPORATION, Tokyo (JP)

(72) Inventors: Yuhei KAWAKAMI, Musashino-shi, Tokyo (JP); Hideaki KIMURA, Musashino-shi, Tokyo (JP); Akihiro MORITA, Musashino-shi, Tokyo (JP)

(73) Assignee: NIPPON TELEGRAPH AND TELEPHONE CORPORATION, Tokyo (JP)

(21) Appl. No.: 17/925,823

(22) PCT Filed: May 22, 2020
(86) PCT No.: PCT/JP2020/020232

§ 371 Date: Nov. 16, 2022

(51) Int. Cl. H04L 45/02

(52) U.S. Cl. CPC H04L 45/02; H04L 45/66

(57) ABSTRACT

In the flush of an FDB, as the number of user bases increases, more SWs are required to flush, and an influence on another user also increases due to flooding. The lapse of an aging time causes long-time communication interruption depending on network specifications and apparatus settings. In order to complete transmission of a user frame from the base after an accommodation change, it is necessary not only to do work of a communication carrier side but also to enter a user base.

The present disclosure is a communication apparatus including a signal reception unit that receives a signal, a signal transmission unit that transmits a signal, and a frame generation unit that generates a control frame for updating a forwarding database (FDB) of a relay network on the basis of FDBs of apparatuses connected to the relay network. The signal transmission unit transmits the control frame generated by the frame generation unit to each of the apparatuses connected to the relay network.

### TECHNICAL FIELD

The present invention relates to an FDB update technology in an L2 network.

### BACKGROUND ART

In a case where the accommodation of a user base is changed in a layer 2 (hereinafter, referred to as L2) network (hereinafter, may be referred to as L2 NW), when a record before the accommodation change remains in a forwarding database (FDB), a frame is continuously transmitted to a port before the accommodation change and a base after the accommodation change is not able to receive a downlink frame. In order to update the FDB and receive the downlink frame, measures have been taken such as flushing the FDB of a relay switch (hereinafter, referred to as a switch (SW)), waiting for the aging time of the relay SW, and transmitting a user frame from a base after the accommodation change to each base so as to update the FDB.

### CITATION LIST

### Patent Literature

PTL 1: JP 2017-108264

### SUMMARY OF THE INVENTION

### Technical Problem

However, in the flush of the FDB, as the scale of the L2 NW increases, more SWs are required to flush, and an influence on another user also increases due to flooding. The lapse of an aging time causes long-time communication interruption depending on network specifications and apparatus settings. In order to complete transmission of a user frame from the base after an accommodation change, it is necessary not only to do the work of a communication carrier side but also to enter a user base.

### Means for Solving the Problem

In the present disclosure, an accommodation SW before the accommodation change and an accommodation SW after the change are connected (for example, may be logically connected), a media access control (MAC) address, a virtual local area network (VLAN) ID, and the like of a corresponding apparatus held by the accommodation SW before the change are transmitted to the accommodation SW after the change, and the accommodation SW after the change broadcasts a control frame assigned a tag of the VLAN ID to a network by using the received MAC address as a source address.

Specifically, a communication apparatus includes: a signal reception unit configured to receive a signal; a signal transmission unit configured to transmit a signal; and a frame generation unit configured to generate a control frame for updating a forwarding database (FDB) of a relay network on the basis of FDBs of apparatuses connected to the relay network, wherein the signal transmission unit transmits the control frame generated by the frame generation unit to each of the apparatuses connected to the relay network.

Specifically, a communication method of the present disclosure includes: generating, by a frame generation unit, a control frame for updating a forwarding database (FDB) of a relay network on the basis of FDBs of apparatuses connected to the relay network; and transmitting, by a signal transmission unit, the control frame generated by the frame generation unit to each of the apparatuses connected to the relay network.

Specifically, a system of the present disclosure is a system in which a device installed outside the communication apparatus performs at least a part of functions provided in a communication apparatus according to the present disclosure.

Specifically, a system of the present disclosure is a communication system in which a plurality of accommodation switches are communicably connected to the relay network, and is a system in which at least one of the plurality of accommodation switches functions as a communication apparatus according to the present disclosure.

Specifically, a program of the present disclosure is a program causing a computer to function as functional units provided in the communication apparatus according to the present disclosure, and is a program causing the computer to perform steps provided in a communication method performed by a communication apparatus according to the present disclosure.

### Effects of the Invention

According to the present disclosure, since each SW can update an FDB by receiving a control frame, the flush of the FDB becomes unnecessary, and communication is possible in an apparatus after an accommodation change without waiting for the lapse of an aging time. Furthermore, it is also possible to perform accommodation change work without a communication carrier entering a base after the accommodation change.

### BRIEF DESCRIPTION OF DRAWINGS

FIG. 1 illustrates a schematic configuration of the present disclosure.

FIG. 2 illustrates an example of a control frame generated in the present system.

FIG. 3 illustrates an example of a port configuration of an accommodation SW 91.

FIG. 4 illustrates a configuration example of an accommodation SW of a first embodiment.

FIG. 5 illustrates an FDB update procedure in the first embodiment.

FIG. 6 illustrates a configuration example of an accommodation SW of a second embodiment.

FIG. 7 illustrates an FDB update procedure in the second embodiment.

FIG. 8 illustrates a generation example of an FDB list.

FIG. 9 illustrates a configuration example of an accommodation SW of a third embodiment.

FIG. 10 illustrates an FDB update procedure in the third embodiment.

FIG. 11 illustrates an FDB update procedure in a fourth embodiment.

FIG. 12 illustrates an example of a flowchart of an accommodation SW in the fourth embodiment.

### DESCRIPTION OF EMBODIMENTS

Hereinafter, embodiments of the present disclosure will be described in detail with reference to the drawings. Further, the present disclosure is not limited to the embodiments described below. These examples of the embodiments are merely examples, and the present disclosure can be implemented in forms in which various modifications and improvements are added based on knowledge of those skilled in the art. Constituent elements with the same reference signs in the specification and the drawings are assumed to be the same constituent elements.

Outline of Invention

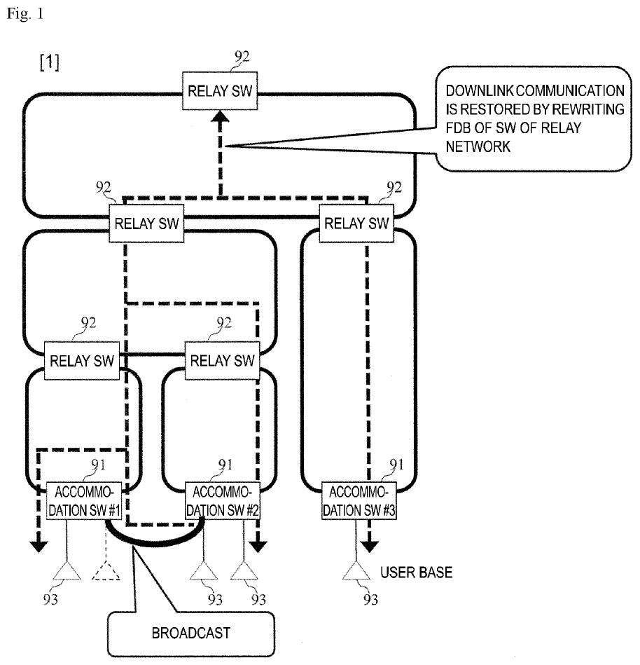

FIG. 1 illustrates a system configuration of the present disclosure. The present disclosure is an L2 network system in which a plurality of accommodation SWs 91 are communicably connected to relay SWs 92. At least one of the plurality of accommodation SWs 91 functions as a communication apparatus of the present disclosure. The L2 network system is referred to as a relay network.

The accommodation SW 91 includes an access port connected to a user base 93 and a relay port connected to the relay SW 92. In the present disclosure, FDB is updated without flushing FDB for the accommodation SW 91 and the relay SW 92. The accommodation SW 91 has a function of holding a record of an FDB for each port for a certain period of time. Furthermore, the accommodation SW 91 has a function of frame-transmitting a set of an MAC address and a VLAN recorded in the FDB as a source MAC address and a VLAN. In the present disclosure, an accommodation SW 91#2 before a change is connected to an accommodation SW 91#1 after a change, and broadcast communication is performed using the above function. This makes it possible for all the relay SWs 92 and the accommodation SWs 91 on a network belonging to the corresponding VLAN to update the FDB. When no VLAN is used, the accommodation SW 91 may perform broadcast communication by using the MAC address recorded in the FDB as the source MAC address.

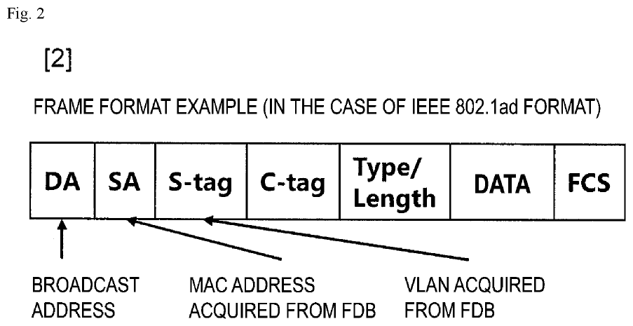

FIG. 2 illustrates an example of a control frame generated in the present system. The frame format illustrated in FIG. 2 indicates the case of an IEEE 802.1ad format.
Description Address (DA): FF: FF: FF: FF: FF: FF
Source Address (SA): MAC address acquired from FDB list
S-tag: VLAN acquired from FDB list
C-tag: Option
Type/Length: unique value set by communication carrier
Data: 00 . . . 0 (42 bytes)
FCS (Frame Check Sequence)
   However, the frame format is not limited to this format, and any frame format corresponding to the L2 network system can be used.

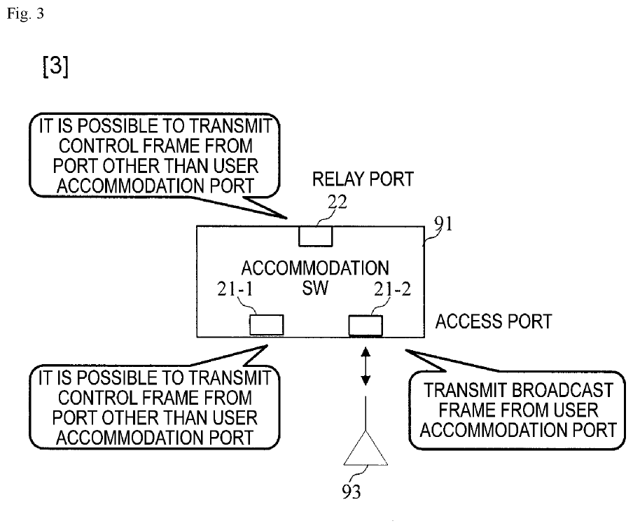

FIG. 3 illustrates an example of a port configuration of the accommodation SW 91. An access port 21-1 is not connected to the user base 93, an access port 21-2 is connected to the user base 93, and a relay port 22 is connected to the relay SW 92. The accommodation SW 91 of the present system has a function of transmitting a generated control frame from the relay port 22 to the network. Furthermore, the accommodation SW 91 is capable of transmitting the control frame from the access port 21-1 and the relay port 22, other than the access port 21-2 that is accommodating the user base 93.

The present disclosure enables the FDB update of a relay network to be performed only by a communication carrier by adopting this configuration. This reduces communication influence and the number of work target apparatuses as compared to FDB flush. The present disclosure is also applicable to changing a transfer destination of an encapsulated frame such as IEEE 802.1ah.

### First Embodiment

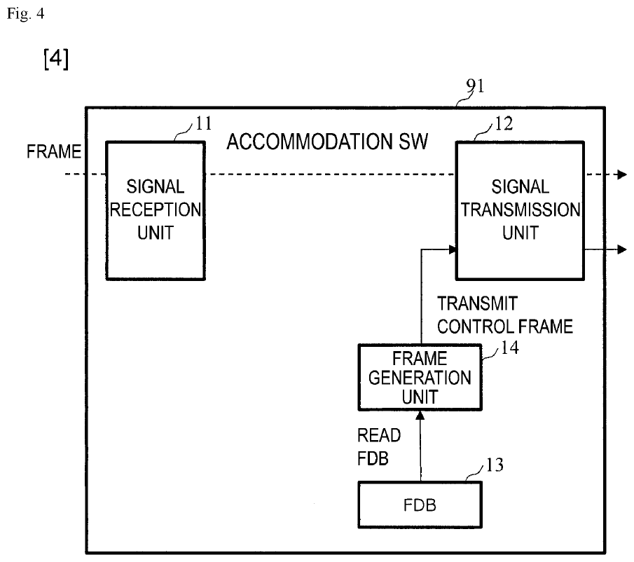

FIG. 4 illustrates a configuration example of the accommodation SW of the present embodiment. The accommodation SW 91 of the present embodiment includes a signal reception unit 11, a signal transmission unit 12, an FDB 13, and a frame generation unit 14. The accommodation SW 91 of the present disclosure can also be implemented by a computer and a program, and the program can be recorded in a recording medium or provided through a network. The same applies to the following embodiments.

The signal reception unit 11 is an interface that receives input signals from the outside. The signal transmission unit 12 is a functional unit that transmits a frame to the outside as an output signal.

The FDB 13 is a functional unit that holds a forwarding table of an apparatus, and holds, for a frame received by the signal reception unit 11, a set of information on a source MAC address, a VLAN, and a port that received the frame.

The frame generation unit 14 is a functional unit that reads the FDB and generates a control frame. The control frame is transmitted from the signal transmission unit 12.

The signal reception unit 11, the signal transmission unit 12, and the FDB 13 are the same functional units as those in the related art.

Detailed operations of the frame generation unit 14 will be described below.

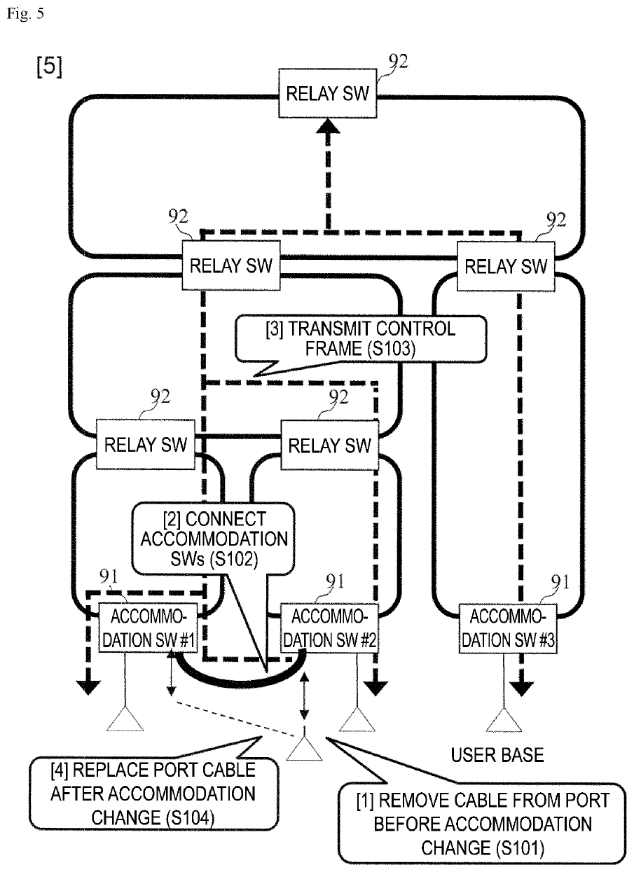

FIG. 5 illustrates an FDB update procedure in the present embodiment.
S101: A cable for the user base 93 connected to an accommodation SW 91#2 before an accommodation change is removed.
S102: A communication path between the accommodation SW 91#2 and SW 91#1 is established by connecting ports before and after the accommodation change with a cable. For example, the access port of the accommodation SW 91#1 and the access port of the accommodation SW 91#2 are communication-connected. The connection between the accommodation SWs 91#1 and 91#2 is not limited to a physical connection, and can also be a logical connection.
S103: The accommodation SW 91#2 before the accommodation change generates a control frame by using a set of the MAC address and the VLAN of an FDB entry for a corresponding port as a source MAC address and a VLAN. The signal transmission unit 12 provided in the accommodation SW 91#2 broadcasts the generated control frame from the communication path connected at step S102. The control frame is transmitted to the accommodation SW 91#1 and transferred from the accommodation SW 91#1 to each relay SW 92. This makes it possible for all the relay SWs 92 and the accommodation SWs 91 on a network belonging to a corresponding VLAN to update the FDB with respect to the MAC address existing in the FDB entry acquired from the accommodation SW 91#2.
S104: The cable between the accommodation SWs 91 is removed from the access port of the accommodation SW 91#1 after the accommodation change, and the accommodation SW 91#1 and the user base 93 are connected with a cable.

At step S103, the accommodation SW 91#2 does not transmit the control frame, and the accommodation SW 91#1 after the accommodation change can transmit the control frame. In this case, the accommodation SW 91#1 receives a command transmitted from accommodation SW 91#2 before the accommodation change, and the frame generation unit 14 provided in the accommodation SW 91#1 generates a control frame.

### Second Embodiment

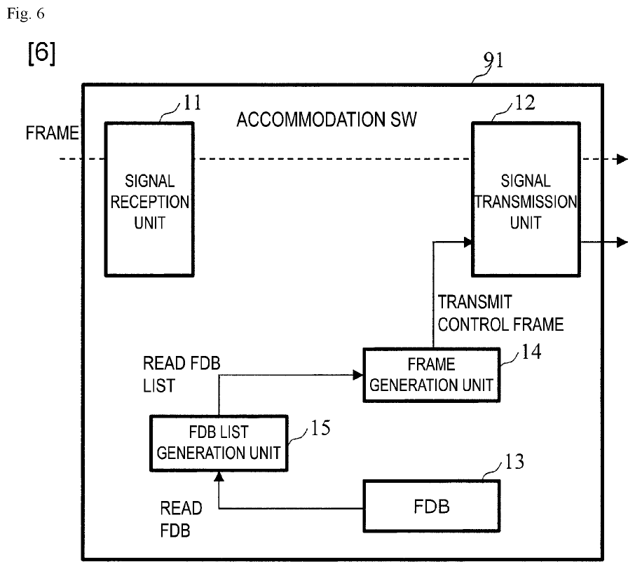

FIG. 6 illustrates a configuration example of an accommodation SW of a second embodiment. The accommodation SW 91 of the present embodiment includes the signal reception unit 11, the signal transmission unit 12, the FDB 13, an FDB list generation unit 15, and the frame generation unit 14.

The signal reception unit 11 is an interface that receives input signals from the outside.

The signal transmission unit 12 is a functional unit that transmits a frame to the outside as an output signal.

The FDB 13 is a functional unit that holds a forwarding table.

The FDB list generation unit 15 is a functional unit that reads an FDB, and generates, updates, and holds an FDB list.

The frame generation unit 14 is a functional unit that reads the FDB list generated by the FDB list generation unit 15 and generates a control frame. The control frame is transmitted from the signal transmission unit 12.

The signal reception unit 11, the signal transmission unit 12, and the FDB 13 are the same functional units as those in the related art. Detailed operations of the FDB list generation unit 15 and the frame generation unit 14 will be described below.

The characteristic of the second embodiment is that the FDB list generation unit 15 is included. It is assumed that various relay SWs exist in the L2 network, different relay SWs may hold different MAC address information, and different aging times may be set in different relay SWs 92. Therefore, although the information is deleted from the FDB of the user accommodation SW 91 due to an excess of the aging time, there is a possibility that the information may be held in the FDB of any relay SW 92 in the L2 network. In order to avoid such a problem, the FDB list generation unit 15 generates an FDB list that holds FDB-related information corresponding to the longest aging time among the SWs in the L2 network.

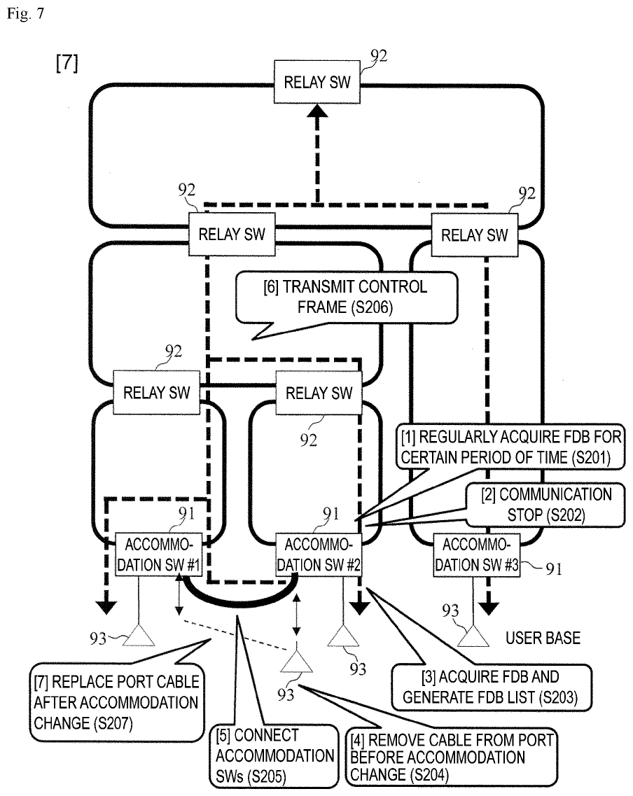

FIG. 7 illustrates an FDB update procedure of the present embodiment.
S201: In the accommodation SW 91#2 before the accommodation change, the FDB list generation unit 15 regularly acquires and records the FDB held by the FDB 13.
S202: Communication to the accommodation SW 91#2 that accommodates a corresponding user base 93 is stopped. For example, there are path abolition, cable removal, apparatus removal at the user base 93, and the like. Hereinafter, there is no FDB update addressed to a base to be subjected to an accommodation change on the L2 network.
S203: In the accommodation SW 91#2 before the accommodation change, the FDB list generation unit 15 reads the latest FDB held by the FDB 13 and merges the read FDB with the recorded FDB list to generate an FDB list.
S204: The cable for a user base connected to the accommodation SW 91#2 before the accommodation change is removed.
S205: A communication path is established between the accommodation SWs 91 by connecting the access ports of the accommodation SW 91#1 and 91#2 before and after the accommodation change with a cable.
S206: In the accommodation SW 91#2 before the accommodation change, the frame generation unit 14 generates a control frame by using a set of an MAC address and a VLAN for a corresponding port in the FDB list as a source MAC address and a LAN. The signal transmission unit 12 broadcasts the generated control frame. This makes it possible for all the relay SWs 92 and the accommodation SWs 91 on a network belonging to a corresponding VLAN to update the FDB.
S207: The cable between the accommodation SWs 91 is removed from the access port of the accommodation SW 91#1 after the accommodation change, and the accommodation SW 91#1 and the user base 93 are connected with a cable.

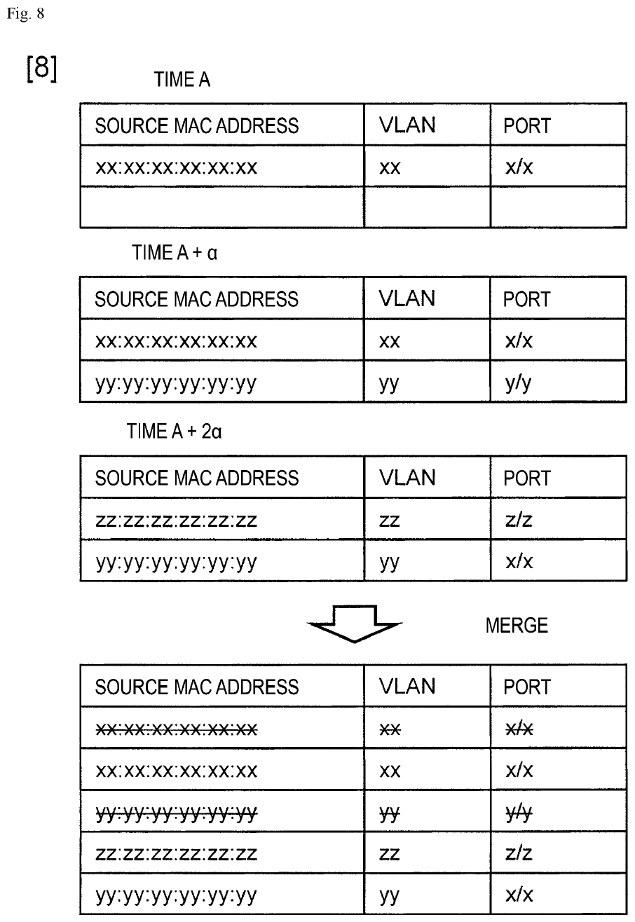

An apparatus adopting the present disclosure has the following functions in addition to the basic function of the L2 SW.
Regularly acquires FDB information. For example, as illustrated in FIG. 8, the FDB list generation unit 15 acquires the FDB information at time A, time A+α, and time A+2α.
As illustrated in FIG. 8, the FDB list generation unit 15 merges the acquired FDB information to generate and hold an FDB list including FDBs with which communication has been performed for a certain period of time.

With these configurations, even when aging times are different for each SW, all FDBs that may be held by not only the accommodation SW 91 but also the relay SW 92 can be listed.

It is assumed that the interval (=a) for recording the FDB is shorter than an aging time of the SW. Furthermore, it is assumed that the period for holding the recorded FDB is longer than the longest aging time among all SWs belonging to the relay network. Furthermore, when there are a plurality of data with the same set of a source MAC address and a VLAN, the older data is deleted and only the latest data is left.

### Third Embodiment

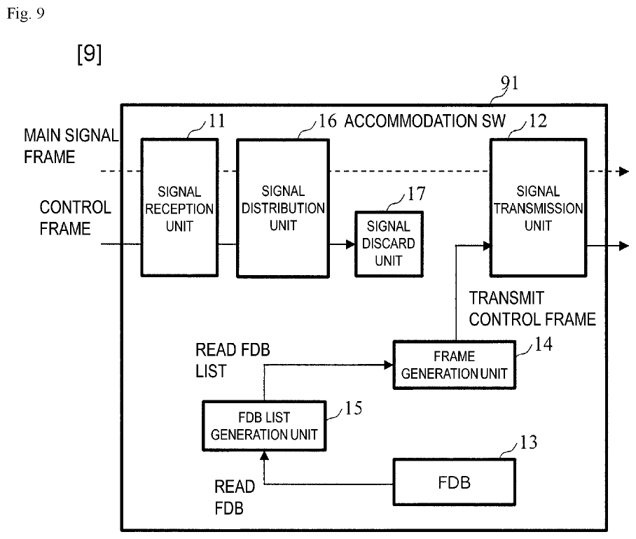

FIG. 9 illustrates a configuration example of an accommodation SW of a third embodiment. The accommodation SW 91 of the present embodiment includes the signal reception unit 11, the signal transmission unit 12, a signal distribution unit 16, a signal discard unit 17, the FDB 13, the FDB list generation unit 15, and the frame generation unit 14.

The signal reception unit 11 is an interface that receives input signals from the outside.

The signal transmission unit 12 is a functional unit that transmits a frame to the outside as an output signal.

The signal distribution unit 16 is a functional unit for distributing a control frame for FDB update among the input signals from the outside to the signal discard unit 17.

The signal discard unit 17 is a functional unit for discarding the control frame for FDB update.

The FDB 13 is a functional unit that holds a forwarding table of an apparatus.

The FDB list generation unit 15 is a functional unit that reads an FDB, and updates and holds an FDB list.

The frame generation unit 14 is a functional unit that reads the FDB list and generates a control frame to be transmitted.

The functions and operations of the signal reception unit 11, the signal transmission unit 12, the FDB 13, the FDB list generation unit 15, and the frame generation unit 14 are the same as those in the second embodiment.

Detailed operations of the signal distribution unit 16 and the signal discard unit 17 will be described below.

The signal distribution unit 16 of the present system has a filtering function in order to prevent the control frame for FDB update from being transmitted to the user base 93. As an example, the filtering function for the control frame having the Type/Length value of “0101 (experimental)” is set in the accommodation SW 91, so that it is possible to prevent the frame from reaching the user base 93. Furthermore, a method of filtering using an OAM (operations, administration, maintenance) frame as the control frame is also conceivable. The filtering method is not limited thereto.

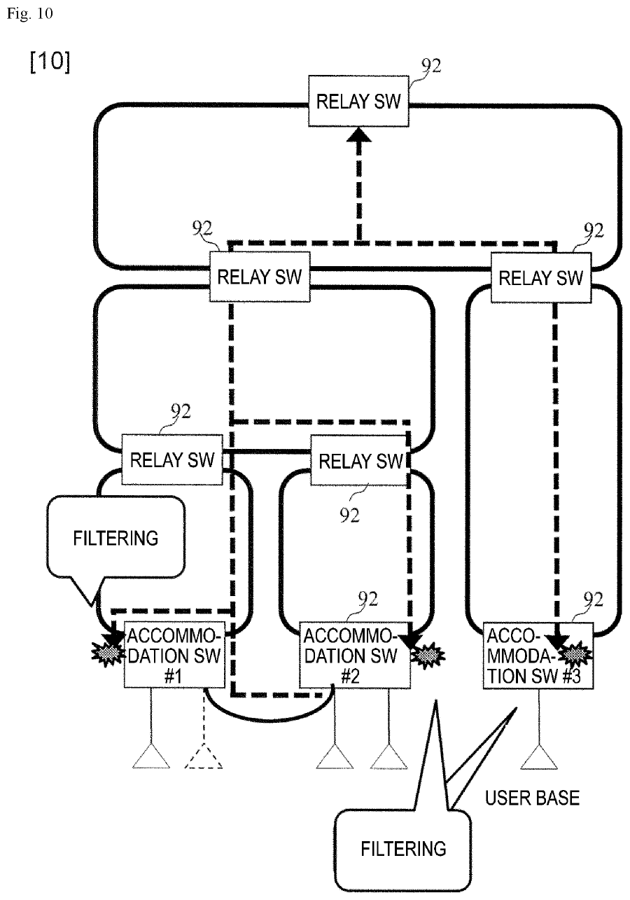

FIG. 10 illustrates an FDB update procedure in the present embodiment. In the present embodiment, steps S101 to S104 in the first embodiment or steps S201 to S207 in the second embodiment are performed. In steps S103 and S206, each of the accommodation SWs 91 discards the control frame by using the signal distribution unit 16 and the signal discard unit 17.

### Fourth Embodiment

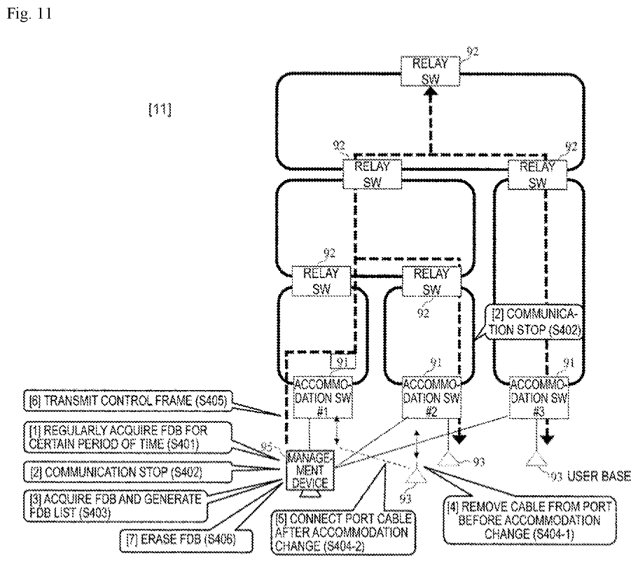

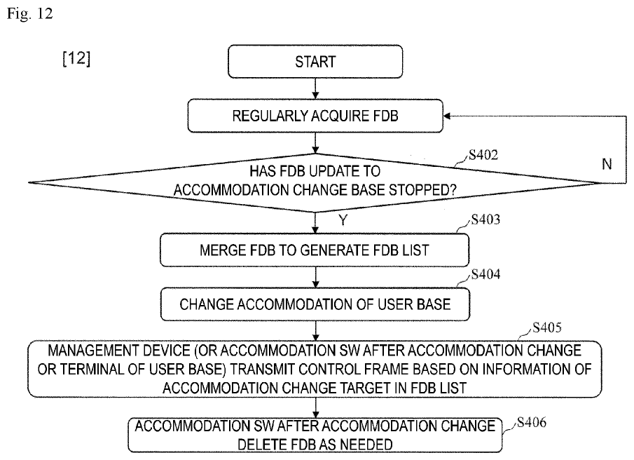

FIG. 11 illustrates an example of a system configuration of the present embodiment. The present embodiment includes a management device 95 connected to the accommodation SWs 91. The management device 95 can use any system having an application connected to the accommodation SW 91. FIGS. 11 and 12 illustrate an FDB update procedure of the present embodiment.
S401: The management device 95 accesses the accommodation SW 91#2 before the accommodation change for a certain period of time, and regularly acquires and records an FDB. The conditions are the same as those of the FDB list generation unit 15 described in the second embodiment, for example.
S402: Communication to the accommodation SW 91#2 that accommodates the corresponding user base 93 is stopped. For example, there are path abolition, cable removal, apparatus removal at the user base 93, and the like. Hereinafter, there is no FDB update addressed to a base to be subjected to an accommodation change base on the L2 network.
S403: The management device 95 reads the latest FDB of the accommodation SW 91#2 before the accommodation change, and merges the read FDB with the recorded FDB list to generate an FDB list.
S404-1: The cable for a user base connected to the accommodation SW 91#2 before the accommodation change is removed.
S404-2: The access port of the accommodation SW 91#1 after the accommodation change and a user base are connected with a cable.
S405: The management device 95 is connected to the accommodation SW 91#1 after the accommodation change. The management device 95 generates a control frame by using a set of an MAC address and a VLAN of an accommodation change target port in the FDB list as a source MAC address and a VLAN, and broadcasts the control frame. This makes it possible for all the relay SWs 92 and the accommodation SWs 91 on a network belonging to the corresponding VLAN to update the FDB.
S406: The accommodation SW 91#1 after the accommodation change erases the FDB of the corresponding VLAN. For example, a cable for the management device 95 connected to the accommodation SW 91#1 is removed.

In the fourth embodiment described above, an embodiment without adding the functions of the accommodation SW 91#1 and 91#2 is possible. The management device 95 can transmit/receive signals to/from the accommodation SW 91 and use any means capable of generating the FDB list. Furthermore, the management device 95 is freely arranged, and, for example, the functions of the management device 95 may be provided in the user base 93.

Furthermore, the present embodiment describes an example in which the management device 95 performs all of steps S401, S402, S403, S404-1, S404-2, S405, and S406, but any apparatus connected to the accommodation SW 91 may perform any of these steps. For example, the accommodation SW 91#2 before the accommodation change may perform the communication stop (S402), or a terminal of the user base 93 or the accommodation SW 91#1 after the accommodation change may perform the transmission of the control frame (S405).

Moreover, the first to third embodiments described above each describe an example in which the signal reception unit 11, the signal transmission unit 12, the FDB 13, the frame generation unit 14, the FDB list generation unit 15, the signal distribution unit 16, and the signal discard unit 17 are all provided in the accommodation SW 91 that is a communication apparatus; however, the present disclosure is not limited to thereto. For example, at least a part of the functions provided in the accommodation SW 91 may be performed by an apparatus installed outside the accommodation SW 91, such as the management device 95 provided in the fourth embodiment.

### INDUSTRIAL APPLICABILITY

The present disclosure can be applied to information and communication industries.

### REFERENCE SIGNS LIST

11 Signal reception unit
12 Signal transmission unit
13 FDB
14 Frame generation unit
15 FDB List generation unit
16 Signal distribution unit
17 Signal discard unit
91 Accommodation switch
92 Relay switch
93 User base
95 Management device

1. A communication apparatus comprising:
a signal reception unit configured to receive a signal;
a signal transmission unit configured to transmit a signal; and
a frame generation unit configured to generate a control frame for updating a forwarding database (FDB) of a relay network on the basis of FDBs of apparatuses connected to the relay network,
wherein the signal transmission unit transmits the control frame generated by the frame generation unit to each of the apparatuses connected to the relay network.

2. The communication apparatus according to claim 1, further comprising: an FDB list generation unit configured to regularly read the FDBs of the apparatuses connected to the relay network and generate an FDB list,
wherein the frame generation unit generates the control frame for updating the FDB of the relay network on the basis of the FDB list generated by the FDB list generation unit.

3. The communication apparatus according to claim 1, further comprising:
a signal distribution unit configured to, when the signal reception unit receives the control frame, distribute the control frame to the signal discard unit; and
a signal discard unit configured to discard the control frame distributed by the signal distribution unit.

4. A communication system in which a device installed outside the communication apparatus according to claim 1 performs at least a part of functions provided in the communication apparatus.

5. A communication system in which a plurality of accommodation switches are communicably connected with the relay network, and at least one of the plurality of accommodation switches functions as the communication apparatus according to claim 1.

6. A communication method comprising:
generating, by a frame generation unit, a control frame for updating a forwarding database (FDB) of a relay network on the basis of FDBs of apparatuses connected to the relay network; and
transmitting, by a signal transmission unit, the control frame generated by the frame generation unit to each of the apparatuses connected to the relay network.

7. A non-transitory computer-readable medium having computer-executable instructions that, upon execution of the instructions by a processor of a computer, cause the computer to function as the communication apparatus according to claim 1.
